(19) United States
(12) Patent Application Publication
(10) Pub. No.: US 2023/0176244 A1
(43) Pub. Date: Jun. 8, 2023

(54) SYSTEMS AND METHODS FOR DETERMINING AND DISTINGUISHING BURIED OBJECTS USING ARTIFICIAL INTELLIGENCE

(71) Applicant: SeeScan, Inc., San Diego, CA (US)

(72) Inventor: Mark S. Olsson, La Jolla, CA (US)

(73) Assignee: SeeScan, Inc., San Diego, CA (US)

(21) Appl. No.: 17/935,564

(22) Filed: Sep. 26, 2022

Related U.S. Application Data
(60) Provisional application No. 63/248,995, filed on Sep. 27, 2021.

(51) Int. Cl. G01V 3/17; G01V 3/08; G01V 3/38

(52) U.S. Cl. CPC G01V 3/17; G01V 3/38; G01V 3/081

(57) ABSTRACT

Systems and methods are provided for determining and distinguishing buried objects using Artificial Intelligence (AI). In an exemplary embodiment, electromagnetic data related to underground utilities and communication systems is collected and provided to a Deep Learning model to build a training set. The Deep Learning model may be trained based on collected sets of Training Data, testing data, and/or user predefined classifiers. The Deep Learning model may use thresholds to determine if a set of data falls within a specific class. Classes may include gas, electric, water, cable, communications lines, or other buried utility and communication classes. Electromagnetic data collected may include multi-frequency measurements, phase measurements, signal strength measurements, and other related measurements. Data may be collected from locators, Sondes, transmitting and receiving antennas, inductive clamps, electrical clips, and satellite systems such as GPS, and other sources. Determined class data may organized and displayed to a user.

### CROSS-REFERENCE TO RELATED APPLICATIONS

This application claims priority under 35 U.S.C. § 119(e) to co-pending U.S. Provisional Pat. Application Serial No. 63/248,995 entitled SYSTEMS AND METHODS FOR DETERMINING AND DISTINGUISHING BURIED OBJECTS USING ARTIFICIAL INTELLIGENCE, filed on Sep. 27, 2021, the content of which is hereby incorporated by reference herein in its entirety for all purpose.

### FIELD

This disclosure relates generally to systems and methods for determining and distinguishing buried objects using Artificial Intelligence (AI). More specifically, but not exclusively, this disclosure relates to systems and methods for collecting electromagnetic signal data and other collected data related to underground utilities and communication systems and classifying that data using a Deep Learning model.

### BACKGROUND

This disclosure relates generally to systems and methods for determining and distinguishing buried objects using Artificial Intelligence (AI). More specifically, but not exclusively, this disclosure relates to systems and methods for collecting utility and communication signal data using utility locating equipment, or other electromagnetic receiving equipment, to gather and measure multiple signal types, including but not limited to multifrequency electromagnetic signals from passive and active lines which are buried and/or underground.

What is needed in the art is the ability to automate the process using Deep Learning by providing Training Data to a Neural Network, and using Artificial Intelligence (AI) to predict, with a very high probability level, specific characteristics of underground objects or assets.

### SUMMARY

This disclosure relates generally to systems and methods for determining and distinguishing buried objects using Artificial Intelligence (AI). More specifically, but not exclusively, this disclosure relates to systems and methods for collecting utility and communication data by using utility locating equipment, or other electromagnetic receiving equipment, to gather and measure multifrequency electromagnetic signals, also known as EM Data, from passive and active lines which are buried and/or underground.

EM Data can be new raw antenna data or signal processed antenna data, or can be data obtained from an antenna array, as an example a dodecahedron configuration, then optionally gradient tensor or Sonde dipole ( including various dipole equation techniques) processing can be applied. Various filters, e.g. particle filters, may be used on the signals and/or data. EM Data can also be broadband/PCA or PCA bandpass data. Trackable dipole devices having utility designator or type elements may also be used to obtain utility related data.

FIG. 1 illustrates different methods for collecting multifrequency electromagnetic data from buried objects associated with utilities or communication systems, as known in the prior art. Underground objects may include power lines, electrical lines, gas lines, water lines, cable and television lines, and communication lines. Power and electrical lines may be single phase, three phase, passive, active, low or high voltage, and low or high current. Various lines may be publicly or privately owned. Data collected from various underground objects may be single frequency or multifrequency data, and may include data from a large range of sources. For instance collected data may include electromagnetic data (EM), ground penetrating radar data (GPR), acoustic data, imaging data, and tomography data, etc. Collected data may also include real-time and historical data. For instance, weather data, weather history, temperature data, humidity data, and soil conditions including soil type, soil moisture, ground conductivity, etc. Sewers and storm drains flow downhill due to gravity, therefore, it may be useful to know the slope or inclination of the ground surface and/or pipes or conduits. This data may be observable in some instances. Collected data may also include time data including time of day, week, month, or year data.

Collected multifrequency data may be obtained by devices using a GeoLocating Receiver (GLR), or other devices and methods well known in the art. Collected data may form a suite of data which may include, for example, multifrequency electromagnetic data, imaging data, mapping data which may include depth and orientation data, current and voltage data, even and odd harmonics, active and passive signals, spatial relationships to other lines and objects, fiber optic data, etc. In some embodiments, collected data may include data obtained from an active transmitter, e.g. a GeoLocating Transmitter (GLT), connected to a utility indication. Data may also be collected using a Laser Range Finder. One example of collecting utility data using a Laser Range Finder is Applicant’s co-owned U.S. Pat. Application 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES

A utility indication may include utility asset tagging with a laser rangefinder to name a tagged utility asset or object.

The ability to go out in the field and locate various underground objects or assets associated with utilities and communication systems, store large amounts of data, and quickly and accurately analyze the data to determine asset characteristics such as the types of underground assets, electrical characteristics, what the assets are connected to, and who owns them is currently very limited. It would also be desirable to understand how, for example, a phone system is grounded to other lines since they are all connected. If above ground data was also available, also known as “ground truth data,” this data could also be included in the data suite and be used to determine origin and ownership of assets. For instance, are the underground assets part of the equipment owned by AT&T®, Verizon®, T-Mobile®, the local cable or utility company, etc. Processing, understanding, and classifying this enormous amount of data requires the ability to learn and notice patterns. This task is too complex for humans to perform but perfectly suited for Artificial Intelligence (AI).

Accordingly, the present invention is directed towards addressing the above-described problems and other problems associated with collecting very large sets of multifrequency electromagnetic data associated with buried objects, processing that data, and predicting with a high degree of probability the type and source of the buried object associated with the data.

Once collected, multifrequency electromagnetic data may be combined with other data, for instance user predefined classifier data, ground truth data, obstacle data, etc., and provided to a processor which outputs “Training Data”. Ground truth data may consist of visually observable data that a user would notice about specific assets such as type of asset, location, connections, ownership, utility box or junction data, obstacle data, etc. Obstacle data may be any type of observable obstacle which may or may not make it harder to collect data at a specific location: for instance a wall, pipe, building, signage, waterway, equipment, etc.

The Training Data is then provided to at least one Neural Network for processing using Artificial Intelligence (AI). Training Data is labeled data used to teach AI models or machine learning algorithms to make proper decisions. In machine learning, data labeling is the process of identifying raw data (images, text files, videos, etc.) and adding one or more meaningful and informative labels to provide context so that a machine learning model can learn from it.

A Neural Network is a method in artificial intelligence that teaches computers to process data in a way that is inspired by the human brain. It is a type of machine learning process, called Deep Learning, that uses interconnected nodes or neurons in a layered structure that resembles the human brain. Neural Networks using AI rely on Training Data to learn and improve analysis and prediction accuracy. By analyzing the Training Data, and recognizing patterns using Deep Learning, the Neural Network can classify the collected data based on a predicted probability. Classified data may then be displayed and presented to a user.

Neural Machine Translation (NMT), which is a modern technology based on machine learning and AI, uses an artificially produced Neural Network. This Deep Learning technique, when translating text and/or language, looks at full sentences, not only individual words. Neural Networks require a fraction of the memory needed by statistical methods. They work far faster. Deep Learning or Artificial Intelligence applications for translation appeared first in speech recognition in the 1990s. The first scientific paper on using Neural Networks in machine translation appeared in 2014. The article was followed rapidly by many advances in the field. In 2015 an NMT system appeared for the first time in Open MT, a machine translation competition. From then on, competitions have been filled almost exclusively with NMT tools.

The latest NMT approaches use what is called a bidirectional recurrent Neural Network, or RNN. These networks combine an encoder which formulates a source sentence for a second RN-N, called a decoder. A decoder predicts the words that should appear in the target language. Google uses this approach in the NMT that drives Google Translate. Microsoft uses RNN in Microsoft Translator and Skype Translator. Both aim to realize the long-held dream of simultaneous translation. Harvard’s NLP (Natural Language Processing) group recently released an open-source Neural Machine Translation system, OpenNMT.Facebook, which is involved in extensive experiments with open source NMT, learning from the language of its users (source: http://sciencewise.info/media/pdfrl507.08818v1.pdf). Harvard NLP group studies machine learning methods for processing and generating human language. They are also interested in mathematical models of sequence generation, challenges of Artificial Intelligence grounded in human language, and the exploration of linguistic structure with statistical tools.

In one aspect, a user may walk, ride, or drive along a road, street, highway, or various other terrain, while using a locating device with the ability to measure and collect buried or underground multifrequency electromagnetic data at a desired location. The locating device may include a locator, Sonde, transmitting antenna, receiving antenna, transceiver, a satellite system, or any other measuring or locating device well known in the art. The assets may include underground lines that are passive or active.

Other forms of data may also be collected using various methods and techniques well known in the art. For instance, data may include imaging data taken from a camera, received data measured by applying a current, voltage, or similar property to an underground line and then measuring the resultant current or voltage at various points along that line or other lines, either by a hardwired connection, or wirelessly, which may also include inductive measurements.

Collected data may include, for example, multifrequency electromagnetic data, imaging data, mapping data which may include depth and orientation data, current and voltage data, even and odd harmonics, active and passive signals, spatial relationships to other lines and objects, fiber optic data, etc. Collected data may be single phase (1ϕ) or multiphase: for example, three phase (3ϕ). Collected data could also include Phase Difference Data. As an example, in the USA where the electrical power utility frequency is 60 Hz, the phase differences between narrow band 60 Hz harmonic signals could be extracted and used as Training Data.

In some instances, data related to time of day, week, or year, weather data, and historical data related to residential, and/or business power usage data, is very useful in helping AI predict current and future load, grid harmonic, and usage patterns. For instance during hot days business and/or residential loads may increase because of the additional use of air conditioning equipment. Harmonics can vary greatly with the load variations. These patterns in turn, can help AI predict additional utility system characteristics.

Processing or preprocessing of Training Data could be performed real-time or at a later time (post-processing). For instance, Collected Data and Other Data could be stored in local or remote memory, including the Cloud, and post-processed (as opposed to real-time processing), and then provided to a Neural Network as Training Data. Additionally, the Neural Network itself could process and analyze the Training Data in real-time, or post-process the data at a later time.

In one aspect, some or all of the collected underground data may be combined with additional data from other sources to form a “Data Suite.” Types of additional data are almost limitless and are well known in the art. For example, additional data may include data already known about underground assets such as type of equipment, orientation, connections, manufacturer, ownership, etc. Additional data may also include observational data observed below ground, for instance, as seen in an open pipe or trench, or with an underground camera inside a pipe or conduit, etc. Observational data may also include above ground data, such as specific equipment, layout of equipment, manufacturer information placed on equipment, etc. Observed or measured above ground data is also almost limitless and well known in the art: for instance, utility boxes, power poles and lines, radio and cellular antennas, transformers, observable connections, line and pipe paths, conduits, etc.

Once collected, the Suite of Data by itself, or in combination with user defined underground asset classification or category data, is provided as Training Data, also known as a “Training Data Suite,” for Deep Learning to one or more Neural Networks. The Neural Networks are programmed to use Artificial Intelligence (AI) for determining with a high probability of accuracy specific information about the underground or buried assets. In one aspect, specific information or characteristics may include types of underground assets, electrical characteristics, what the assets are connected to, and who owns them. Some of this information will be geographic location specific. For instance, in the USA and Canada, household and business power is typically delivered at 110 VAC, 60 Hz; however, in Europe it is delivered at 230 VAC, 50 Hz. There are of course many other examples. Also, the types of underground assets, types of connections, and companies who own them may vary greatly from city to city, among states, regions, and from country to country.

In another aspect, specific information could include right of way information, location and/or direction information, and even damaged asset information. As an example, if it is known or learned that specific electrical characteristics are present at the input of an electrical line or powerline, it may be expected that specific electrical characteristics should be present at the output. However, if the output is not as expected, it could be assumed that the line itself or other related equipment is damaged or malfunctioning.

In another aspect, one or more physics models of ground return can be added as Training Data. AI then may be be used to associate patterns caused by the flow of AC and DC electrical currents in the ground that affect the measured electromagnetic (EM) patterns associated with buried utilities. AI can also be used to identify the presence or absence of a buried utility as an output. Additional Training Data may include multi-frequency transmitters where several frequencies are coupled to a specific known utility at an above ground point, Gas Sniffers including Methane Detection to determine if a gas line is present.

In one aspect, AI can use GNSS Satellite Data to determine a fix (position), or GNSS processors can provide fix data to AI, and AI can identify patterns in this data to improve accuracy. INS (Inertial Navigation System) Sensors can use one or more of raw accelerometer, gyroscope, and magnetometer data to determine orientation, or the output of the INS system can be used as Training Data to enable AI to estimate better (more accurate) location results.

In one aspect, the Training Data would be dynamically updated. Updates could be incremental, for instance at specific time intervals, or continuous. Also, Training Data sets could be different in different geographic locations. For instance, Training Data sets could be updated to take into account different electrical and other characteristics due to local, regional, or country differences, etc. As an example, AI predicted results could be compared to known results in order to test result accuracy. The term “predicted results” takes into account the fact that AI is making a probability or likelihood prediction that the data it has analyzed corresponds to a certain utility system, and to specific characteristics of the system. AI may also be used to extrapolate paths in data gaps, as well as to group utility objects.

In another aspect, Testing Data, and/or Quality Metrics could be provided to the Neural Network to get a confidence level of the accuracy of and results determined by AI.

In this disclosure the terms “Deep Learning” and “Artificial intelligence (AI)” are used synonymously. However, there is actually a subtle difference. Deep Learning is an AI function that mimics the workings of the human brain in processing data for use in detecting objects, recognizing speech, translating languages, and making decisions. Deep Learning AI is able to learn without human supervision, drawing from data that is both unstructured and unlabeled (source: Investopedia.com). Deep Learning is a subset of machine learning where artificial Neural Networks, algorithms inspired by the human brain, learn from large amounts of data. Deep Learning allows machines to solve complex problems even when using a data set that is very diverse, unstructured and interconnected (source: Forbes.com). The task of analyzing and making sense of enormous amounts of collected data related to multifrequency electromagnetic data, as well as the addition of additional related data joined to form a Data Suite is too complex for humans to perform but perfectly suited for Artificial Intelligence (AI). In one aspect, AI, which is perfectly suited for pattern recognition, provides a user with classification and type probabilities for underground as well as above ground assets. Results may be provided to a user in numerous ways, including visually rendered on a display, audibly, tactilely, etc.

In another aspect, received and analyzed Training Data may allow AI to classify or categorize certain types of equipment. As an example, a group of underground objects may exhibit 25 different frequencies with each object having a certain amount of energy or current, each object being at a different depth and orientation from the other objects and the ground at specific locations. AI should be able to use the data to make a probability guess about what kind of utility is underground and even who the owner is if ownership classification data was part of the Data Suite used as Training Data.

In another aspect, a Neural Network using AI may learn that in a utility system every two houses have a street crossing and always include installed electricity, cable TV, and phone lines. It may also learn that gas lines are between houses, water meters are present and have leads with certain depths, utilities have certain depths and frequencies, utilities are located with respect to specific addresses on certain positions on the street, and that utilities are running along or across the street. Additionally it may be determined which frequency of passive energy is being measured on a specific utility if you get AM frequencies in the utility and the ratio of harmonics on the utility. These are all patterns AI can recognize and use to estimate a probability that the utility is a waterline, or a gas line, or a fiber optic cable, or more specifically for example, an AT&T®) fiber optic cable. AI can make this assumption because it has learned that AT&T® uses a certain type of equipment and that the equipment has a certain type of harmonics because it is made, for instance, by Samsung(R), and it has learned that other lines are made by other companies. It would be understood by one of ordinary skill in the art that a Neural Network may use one or both of a classification or a regression algorithm for problem solving. Regression analysis may be used in situations where input values are continuously changing.

As another example, observed data included in a Training Data Suite may include a pipe, manhole cover, valve, or utility box that is labeled SDGE (San Diego Gas & Electric). So it can be assumed that this type of equipment has a certain type of frequency. AI can look at all the Training Data at once and predict with a high probability, that it is, for example, an SDGE, three phase (3ϕ) powerline, that feeds nearby houses with single phase (1ϕ) power, or that it is a powerline going to an industrial feed because it has all of the different and correct 3ϕ harmonics.

The AI could also learn and form associations with the Training Data. For instance, in one aspect AI could determine there is a traffic light near a specific location, and that waterlines are grounded to a powerline, and that a specific waterline is associated with a specific powerline because the bleeding off of additional harmonic energy into the waterline is different than that bleeding off of additional harmonic energy into the power line. AI might then notice that the same waterline is three blocks down because it has learned how high frequencies bleed off faster than low frequencies, and the fourth house down is starting to bleed off some additional harmonic energy into the gas line ten houses away as well, based on the frequency content of the spectral signature of a given target utility that is close in spatial distance. AI does not need to know physics or do ground modeling as a human would or a computer program would, all AI has to do is recognize patterns, make sense of the patterns, and make sense of the relationship between different patterns.

Training Data can include quality metrics and quality data including position quality, inertial navigation system (INS)/orientation data quality, electromagnetic (EM) calibration quality, proximity/distance data quality. Physics models of ground return current can also be added, as well as data related to other interfering utilities.

AI can use its training to output the probability of specific attributes being related to specific underground assets and the utilities the assets are related to. More specifically AI can determine the probability that certain things, e.g. utility assets or objects, physical location objects or characteristics, non-utility equipment, etc., are related to other things, the nature between the different things, how far away the connections between the different things are, how far the connection between two things might be from where a current or previous measurement was taken based on the difference between the two things, and if some ground truth data was provided as part of the Training Data, very specific information like who owns or operates specific equipment, e.g. AT&T®, Verizon®, T-Mobile®, etc. AI can also be used to distinguish a specific communication standard used by a specific company, for instance 4G vs 5G cellular protocols, etc.

Some prior art systems exist that allow for frequency monitoring and the use of computers to calculate certain system parameters using various methods, for instance using Eigenvalues. However, these systems are very slow and do not allow the processing of large blocks of data in real or near real-time. Even if they could be programmed to accomplish such a task, systems such as these would take days, weeks, or even months to calculate any worthwhile parameters with even a reasonable accuracy. And with very large data sets, a final reliable solution may never be realized.

Current technology, for instance a cellphone, can be used while going down a street to map the position of things that can be seen. This does not really have much value because it is so limited. Deep Learning which uses AI can be used to map the relationship of things that cannot be seen, for instance underground or buried assets. Once AI data has recognized and characterized specific utility assets relative to a specific location(s), the relationship of those objects to each other, this information along with any geographical map or location information, can be used to create very accurate maps of the various utility equipment at a specific location both above ground and hidden or buried below ground. These maps may then be stored in a database for private or shared use.

Various additional aspects, features, and functions are describe below in conjunction with the Drawings.

Details of example devices, systems, and methods that may be combined with the embodiments disclosed herein, as well as additional components, methods, and configurations that may be used in conjunction with the embodiments described herein, are disclosed in coassigned patents and patent applications including: U.S. Pat. 7,009,399, issued Mar. 7, 2006, entitled OMNIDIRECTIONAL SONDE AND LINE LOCATOR; U.S. Pat. 7,136,765, issued Nov. 14, 2006, entitled A BURIED OBJECT LOCATING AND TRACING METHOD AND SYSTEM EMPLOYING PRINCIPAL COMPONENTS ANALYSIS FOR BLIND SIGNAL DETECTION; U.S. Pat. 7,221,136, issued May 22, 2007, entitled SONDES FOR LOCATING UNDERGROUND PIPES AND CONDUITS; U.S. Pat. 7,276,910, issued Oct. 2, 2007, entitled A COMPACT SELF-TUNED ELECTRICAL RESONATOR FOR BURIED OBJECT LOCATOR APPLICATIONS; U.S. Pat. 7,288,929, issued Oct. 30, 2007, entitled INDUCTIVE CLAMP FOR APPLYING SIGNAL TO BURIED UTILITIES; U.S. Pat. 7,298,126, issued Nov. 20, 2007, entitled SONDES FOR LOCATING UNDERGROUND PIPES AND CONDUITS; U.S. Pat. 7,332,901, issued Feb. 19, 2008, entitled LOCATOR WITH APPARENT DEPTH INDICATION; U.S. Pat. 7,443,154, issued Oct. 28, 2008, entitled MULTI-SENSOR MAPPING OMNIDIRECTIONAL SONDE AND LINE LOCATOR; U.S. Pat. 7,498,797, issued Mar. 3, 2009, entitled LOCATOR WITH CURRENT-MEASURING CAPABILITY; U.S. Pat. 7,498,816, issued Mar. 3, 2009, entitled OMNIDIRECTIONAL SONDE AND LINE LOCATOR; U.S. Pat. 7,336,078, issued Feb. 26, 2008, entitled MULTI-SENSOR MAPPING OMNIDIRECTIONAL SONDE AND LINE LOCATORS; U.S. Pat. 7,518,374, issued Apr. 14, 2009, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. 7,557,559, issued Jul. 7, 2009, entitled COMPACT LINE ILLUMINATOR FOR BURIED PIPES AND CABLES; U.S. Pat. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. 7,619,516, issued Nov. 17, 2009, entitled SINGLE AND MULTI-TRACE OMNIDIRECTIONAL SONDE AND LINE LOCATORS AND TRANSMITTER USED THEREWITH; U.S. Pat. 7,733,077, issued Jun. 8, 2010, entitled MULTI-SENSOR MAPPING OMNIDIRECTIONAL SONDE AND LINE LOCATORS AND TRANSMITTER USED THEREWITH; U.S. Pat. 7,741,848, issued Jun. 22, 2010, entitled ADAPTIVE MULTICHANNEL LOCATOR SYSTEM FOR MULTIPLE PROXIMITY DETECTION; U.S. Pat. 7,755,360, issued Jul. 13, 2010, entitled PORTABLE LOCATOR SYSTEM WITH JAMMING REDUCTION; U.S. Pat. 7,825,647, issued Nov. 2, 2010, entitled METHOD FOR LOCATING BURIED PIPES AND CABLES; U.S. Pat. 7,830,149, issued Nov. 9, 2010, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. 7,864,980, issued January 4,2011, entitled SONDES FOR LOCATING UNDERGROUND PIPES AND CONDUITS; U.S. Pat. 7,948,236, issued May 24, 2011, entitled ADAPTIVE MULTICHANNEL LOCATOR SYSTEM FOR MULTIPLE PROXIMITY DETECTION; U.S. Pat. 7,969,151, issued Jun. 28, 2011, entitled PRE-AMPLIFIER AND MIXER CIRCUITRY FOR A LOCATOR ANTENNA; U.S. Pat. 7,990,151, issued Aug. 2, 2011, entitled TRI-POD BURIED LOCATOR SYSTEM; U.S. Pat. 8,013,610, issued Sep. 6, 2011, entitled HIGH Q SELF-TUNING LOCATING TRANSMITTER; U.S. Pat. 8,035,390, issued Oct. 11, 2011, entitled OMNIDIRECTIONAL SONDE AND LINE LOCATOR; U.S. Pat. 8,106,660, issued Jan. 31, 2012, entitled SONDE ARRAY FOR USE WITH BURIED LINE LOCATOR; U.S. Pat. 8,203,343, issued Jun. 19, 2012, entitled RECONFIGURABLE PORTABLE LOCATOR EMPLOYING MULTIPLE SENSOR ARRAYS HAVING FLEXIBLE NESTED ORTHOGONAL ANTENNAS; U.S. Pat. 8,264,226, issued Sep. 11, 2012, entitled SYSTEM AND METHOD FOR LOCATING BURIED PIPES AND CABLES WITH A MAN PORTABLE LOCATOR AND A TRANSMITTER IN A MESH NETWORK; U.S. Pat. 8,248,056, issued Aug. 21, 2012, entitled A BURIED OBJECT LOCATOR SYSTEM EMPLOYING AUTOMATED VIRTUAL DEPTH EVENT DETECTION AND SIGNALING; U.S. Pat. Application 13/769,202, filed Feb. 15, 2013, entitled SMART PAINT STICK DEVICES AND METHODS; U.S. Pat. Application 13/793,168, filed Mar. 11, 2013, entitled BURIED OBJECT LOCATORS WITH CONDUCTIVE ANTENNA BOBBINS; U.S. Pat. 8,400,154, issued Mar. 19, 2013, entitled LOCATOR ANTENNA WITH CONDUCTIVE BOBBIN; U.S. Pat. Application 14/027,027, filed Sep. 13, 2013, entitled SONDE DEVICES INCLUDING A SECTIONAL FERRITE CORE STRUCTURE; U.S. Pat. Application 14/033,349, filed Sep. 20, 2013, entitled AN UNDERGROUND UTILITY LOCATOR WITH A TRANSMITTER, A PAIR OF UPWARDLY OPENING POCKET AND HELICAL COIL TYPE ELECTRICAL CORDS; U.S. Pat. 8,547,428, issued Oct. 1, 2013, entitled PIPE MAPPING SYSTEM; U.S. Pat. 8,564,295, issued Oct. 22, 2013, entitled METHOD FOR SIMULTANEOUSLY DETERMINING A PLURALITY OF DIFFERENT LOCATIONS OF THE BURIED OBJECTS AND SIMULTANEOUSLY INDICATING THE DIFFERENT LOCATIONS TO A USER; U.S. Pat. Application 14/148,649, filed Jan. 6, 2014, entitled MAPPING LOCATING SYSTEMS & METHODS; U.S. Pat. 8,635,043, issued Jan. 21, 2014, entitled LOCATOR AND TRANSMITTER CALIBRATION SYSTEM; U.S. Pat. 8,717,028, issued May 6, 2014, entitled SPRING CLIPS FOR USE WITH LOCATING TRANSMITTERS; U.S. Pat. 8,773,133, issued Jul. 8, 2014, entitled ADAPTIVE MULTICHANNEL LOCATOR SYSTEM FOR MULTIPLE PROXIMITY DETECTION; U.S. Pat. 8,841,912, issued Sep. 23, 2014, entitled PRE-AMPLIFIER AND MIXER CIRCUITRY FOR A LOCATOR ANTENNA; U.S. Pat. 9,041,794, issued May 26, 2015, entitled PIPE MAPPING SYSTEMS AND METHODS; U.S. Pat. 9,057,754, issued Jun. 16, 2015, entitled ECONOMICAL MAGNETIC LOCATOR APPARATUS AND METHOD; U.S. Pat. 9,081,109, issued Jul. 14, 2015, entitled GROUND-TRACKING DEVICES FOR USE WITH A MAPPING LOCATOR; U.S. Pat. 9,082,269, issued Jul. 14, 2015, entitled HAIITIC DIRECTIONAL FEEDBACK HANDLES FOR LOCATION DEVICES; U.S. Pat. 9,085,007, issued Jul. 21, 2015, entitled MARKING PAINT APPLICATOR FOR PORTABLE LOCATOR; U.S. Pat. 9,207,350, issued Dec. 8, 2015, entitled BURIED OBJECT LOCATOR APPARATUS WITH SAFETY LIGHTING ARRAY; U.S. Pat. 9,341,740, issued May 17, 2016, entitled OPTICAL GROUND TRACKING APPARATUS, SYSTEMS, AND METHODS; U.S. Pat. 9,372,117, issued Jun. 21, 2016, entitled OPTICAL GROUND TRACKING APPARATUS, SYSTEMS, AND METHODS; U.S. Pat. Application 15/187,785, filed Jun. 21, 2016, entitled BURIED UTILITY LOCATOR GROUND TRACKING APPATUS, SYSTEMS, AND METHODS; U.S. Pat. 9,411,066, issued Aug. 9, 2016, entitled SONDES & METHODS FOR USE WITH BURIED LINE LOCATOR SYSTEMS; U.S. Pat. 9,411,067, issued Aug. 9, 2016, entitled GROUND-TRACKING SYSTEMS AND APPARATUS; U.S. Pat. 9,435,907, issued Sep. 6, 2016, entitled PHASE SYNCHRONIZED BURIED OBJECT LOCATOR APPARATUS, SYSTEMS, AND METHODS; U.S. Pat. 9,465,129, issued Oct. 11, 2016, entitled IMAGE-BASED MAPPING LOCATING SYSTEM; U.S. Pat. 9,488,747, issued Nov. 8, 2016, entitled GRADIENT ANTENNA COILS AND ARRAYS FOR USE IN LOCATING SYSTEM; U.S. Pat. 9,494,706, issued Nov. 15, 2016, entitled OMNI-INDUCER TRANSMITTING DEVICES AND METHODS; U.S. Pat. 9,523,788, issued Dec. 20, 2016, entitled MAGNETIC SENSING BURIED OBJECT LOCATOR INCLUDING A CAMERA; U.S. Pat. 9,571,326, issued Feb. 14, 2017, entitled METHOD AND APPARATUS FOR HIGH-SPEED DATA TRANSFER EMPLOYING SELF-SYNCHRONIZING QUADRATURE AMPLITUDE MODULATION (QAM); U.S. Pat. 9,599,449, issued Mar. 21, 2017, entitled SYSTEMS AND METHODS FOR LOCATING BURIED OR HIDDEN OBJECTS USING SHEET CURRENT FLOW MODELS; U.S. Pat. 9,599,740, issued Mar. 21, 2017, entitled USER INTERFACES FOR UTILITY LOCATORS; U.S. Pat. 9,625,602, issued Apr. 18, 2017, entitled SMART PERSONAL COMMUNICATION DEVICES AS USER INTERFACES; U.S. Pat. 9,632,202, issued Apr. 25, 2017, entitled ECONOMICAL MAGNETIC LOCATOR APPARATUS AND METHODS; U.S. Pat. 9,634,878, issued Apr. 25, 2017, entitled SYSTEMS AND METHODS FOR DATA TRANSFER USING SELF-SYNCHRONIZING QUADRATURE AMPLITUDE MODULATION (QAM); U.S. Pat. Application, filed Apr. 25, 2017, entitled SYSTEMS AND METHODS FOR LOCATING AND/OR MAPPING BURIED UTILITIES USING VEHICLE-MOUNTED LOCATING DEVICES; U.S. Pat. 9,638,824, issued May 2, 2017, entitled QUAD-GRADIENT COILS FOR USE IN LOCATING SYSTEMS, U.S. Pat. Application, filed May 9, 2017, entitled BORING INSPECTION SYSTEMS AND METHODS; U.S. Pat. 9,651,711, issued May 16, 2017, entitled HORIZONTAL BORING INSPECTION DEVICE AND METHODS; U.S. Pat. 9,684,090, issued Jun. 20, 2017, entitled NULLED-SIGNAL LOCATING DEVICES, SYSTEMS, AND METHODS; U.S. Pat. 9,696,447, issued Jul. 4, 2017, entitled BURIED OBJECT LOCATING METHODS AND APPARATUS USING MULTIPLE ELECTROMAGNETIC SIGNALS; U.S. Pat. 9,696,448, issued Jul. 4, 2017, entitled GROUND-TRACKING DEVICES AND METHODS FOR USE WITH A UTILITY LOCATOR; U.S. Pat. 9,703,002, issued Jun. 11, 2017, entitled UTILITY LOCATOR SYSTEMS & METHODS; U.S. Pat. Application 15/670,845, filed Aug. 7, 2016, entitled HIGH FREQUENCY AC-POWEISED DRAIN CLEANING AND INSPECTION APPARATUS & METHODS; U.S. Pat. Application 15/681,250, filed Aug. 18, 2017, entitled ELECTRONIC MARKER DEVICES AND SYSTEMS; U.S. Pat. Application 15/681,409, filed Aug. 20, 2017, entitled WIRELESS BURIED PIPE & CABLE LOCATING SYSTEMS; U.S. Pat. 9,746,572, issued Aug. 29, 2017, entitled ELECTRONIC MARKER DEVICES AND SYSTEMS; U.S. Pat. 9,746,573, issued Aug. 29, 2017, entitled WIRELESS BURIED PIPE AND CABLE LOCATING SYSTEMS; U.S. Pat. 9,784,837, issued Oct. 10, 2017, entitled OPTICAL GROUND TRACKING APPARATUS, SYSTEMS & METHODS; U.S. Pat. Application 15/811,361, filed Nov. 13, 2017, entitled OPTICAL GROUND-TRACKING APPARATUS, SYSTEMS, AND METHODS; U.S. Pat. 9,841,503, issued Dec. 12, 2017, entitled OPTICAL GROUND-TRACKING APPARATUS, SYSTEMS, AND METHODS; U.S. Pat. Application 15/846,102, filed Dec. 18, 2017, entitled SYSTEMS AND METHOD FOR ELECTRONICALLY MARKING, LOCATING AND VIRTUALLY DISPLAYING BURIED UTILITIES; U.S. Pat. Application 15/866,360, filed Jan. 9, 2018, entitled TRACKED DISTANCE MEASURING DEVICES, SYSTEMS, AND METHODS; U.S. Pat. 9,891,337, issued Feb. 13, 2018, entitled UTILITY LOCATOR TRANSMITTER DEVICES, SYSTEMS, and METHODS WITH DOCKABLE APPARATUS; U.S. Pat. 9,914,157, issued March, 13, 2018, entitled METHODS AND APPARATUS FOR CLEARING OBSTRUCTIONS WITH A JETTER PUSH-CABLE APPARATUS; U.S. Pat. Application 15/925,643, issued Mar. 19, 2018, entitled PHASE-SYNCHRONIZED BURIED OBJECT TRANSMITTER AND LOCATOR METHODS AND APPARATUS; U.S. Pat. Application 15/925,671, issued Mar. 19, 2018, entitled MULTI-FREQUENCY LOCATING SYSTEMS AND METHODS; U.S. Pat. Application 15/936,250, filed March 26, 208, entitled GROUND TRACKING APPARATUS, SYSTEMS, AND METHODS; U.S. Pat. 9,927,545, issued Mar. 27, 2018, entitled MULTI-FREQUENCY LOCATING SYSTEMS & METHODS; U.S. Pat. 9,928,613, issued Mar. 27, 2018, entitled GROUND TRACKING APPARATUS, SYSTEMS, AND METHODS; U.S. Pat. Application 15/250,666, filed Mar. 27, 2018, entitled PHASE-SYNCHRONIZED BURIED OBJECT TRANSMITTER AND LOCATOR METHODS AND APPARATUS; U.S. Pat. 9,880,309, issued Mar. 28, 2018, entitled UTILITY LOCATOR TRANSMITTER APPARATUS & METHODS; U.S. Pat. Application 15/954,486, filed Apr. 16, 2018, entitled UTILITY LOCATOR APPARATUS, SYSTEMS, AND METHODS; U.S. Pat. 9,945,976, issued Apr. 17, 2018, entitled UTILITY LOCATOR APPARATUS, SYSTEMS, AND METHODS; U.S. Pat. 9,989,662, issued Jun. 5, 2018, entitled BURIED OBJECT LOCATING DEVICE WITH A PLURALITY OF SPHERICAL SENSOR BALLS THAT INCLUDE A PLURALITY OF ORHTOGONAL ANTENNAE; U.S. Pat. Application 16/036,713, issued Jul. 16, 2018, entitled UTILITY LOCATOR APPARATUS AND SYSTEMS; U.S. Pat. 10,024,994, issued Jul. 17, 2018, entitled WEARABLE MAGNETIC FIELD UTILITY LOCATOR SYSTEM WITH SOUND FIELD GENERATION; U.S. Pat. 10,031,253, issued Jul. 24, 2018, entitled GRADIENT ANTENNA COILS AND ARRAYS FOR USE IN LOCATING SYSTEMS; U.S. Pat. 10,042,072, issued Aug. 7, 2018, entitled OMNI-INDUCER TRANSMITTING DEVICES AND METHODS; U.S. Pat. 10,059,504, issued Aug. 28, 2018, entitled MARKING PAINT APPLICATOR FOR USE WITH PORTABLE UTILITY LOCATOR; U.S. Pat. Application 16/049,699, filed Jul. 30, 2018, entitled ONLNI-INDUCER TRANSMITTING DEVICES AND METHODS; U.S. Pat. 10,069,667, issued Sep. 4, 2018, entitled SYSTEMS AND METHODS FOR DATA TRANSFER USING SELF-SYNCHRONIZING QUADRATURE AMPLITUDE MODULATION (QAM); U.S. Pat. Application 16/121,379, filed Sep. 4, 2018, entitled KEYED CURRENT SIGNAL UTILITY LOCATING SYSTEMS AND METHODS; U.S. Pat. Application 16/125,768, filed Sep. 10, 2018, entitled BURIED OBJECT LOCATOR APPARATUS AND METHODS; United States Patent 10,073,186, issued Sep. 11, 2018, entitled KEYED CURRENT SIGNAL UTILITY LOCATING SYSTEMS AND METHODS; U.S. Pat. Application 16/133,642, issued Sep. 17, 2018, entitled MAGNETIC UTILITY LOCATOR DEVICES AND METHODS; U.S. Pat. 10,078,149, issued Sep. 18, 2018, entitled BURIED OBJECT LOCATORS WITH DODECAHEDRAL ANTENNA NODES; U.S. Pat. 10,082,591, issued Sep. 25, 2018, entitled MAGNETIC UTILITY LOCATOR DEVICES & METHODS; U.S. Pat. 10,082,599, issued Sep. 25, 2018, entitled MAGNETIC SENSING BURIED OBJECT LOCATOR INCLUDING A CAMERA; U.S. Pat. 10,090,498, issued Oct. 2, 2018, entitled MODULAR BATTERY PACK APPARATUS, SYSTEMS, AND METHODS INCLUDING VIRAL DATA AND/OR CODE TRANSFER; U.S. Pat. Application 16/160,874, filed Oct. 15, 2018, entitled TRACKABLE DIPOLE DEVICES, METHODS, AND SYSTEMS FOR USE WITH MARKING PAINT STICKS; U.S. Pat. Application 16/222,994, filed Dec. 17, 2018, entitled UTILITY LOCATORS WITH RETRACTABLE SUPPORT STRUCTURES AND APPLICATIONS THEREOF; U.S. Pat. 10,105,723, issued Oct. 23, 2018, entitled TRACKABLE DIPOLE DEVICES, METHODS, AND SYSTEMS FOR USE WITH MARKING PAINT STICKS; U.S. Pat. 10,162,074, issued Dec. 25, 2018, entitled UTILITY LOCATORS WITH RETRACTABLE SUPPORT STRUCTURES AND APPLICATIONS THEREOF; U.S. Pat. Application 16/241,864, filed Jan. 7, 2019, entitled TRACKED DISTANCE MEASURING DEVICES, SYSTEMS, AND METHODS; U.S. Pat. Application 16/255,524, filed Jan. 23, 2019, entitled RECHARGEABLE BATTERY PACK ONBOARD CHARGE STATE INDICATION METHODS AND APPARATUS; U.S. Pat. 10,247,845, issued Apr. 2, 2019, entitled UTILITY LOCATOR TRANSMITTER APPARATUS AND METHODS; U.S. Pat. Application 16/382,136, filed Apr. 11, 2019, entitled GEOGRAPHIC MAP UPDATING METHODS AND SYSTEMS; U.S. Pat. 10,274,632, issued Apr. 20, 2019, entitled UTILITY LOCATING SYSTEMS WITH MOBILE BASE STATION; U.S. Pat. Application 16/390,967, filed Apr. 22, 2019, entitled UTILITY LOCATING SYSTEMS WITH MOBILE BASE STATION; U.S. Pat. Application 29/692,937, filed May 29, 2019, entitled BURIED OBJECT LOCATOR; U.S. Pat. Application 16/436,903, filed Jun. 10, 2019, entitled OPTICAL GROUND TRACKING APPARATUS, SYSTEMS, AND METHODS FOR USE WITH BURIED UTILITY LOCATORS; U.S. Pat. 10,317,559, issued Jun. 11, 2019, entitled GROUND-TRACKING DEVICES AND METHODS FOR USE WITH A UTILITY LOCATOR; U.S. Pat. Application 16/449,187, filed Jun. 21, 2019, entitled ELECTROMAGNETIC MARKER DEVICES FOR BURIED OR HIDDEN USE; U.S. Pat. Application 16/455,491, filed Jun. 27, 2019, entitled SELF-STANDING MULTI-LEG ATTACHMENT DEVICES FOR USE WITH UTILITY LOCATORS; U.S. Pat. 10,353,103, issued Jul. 16, 2019, entitled SELF-STANDING MULTI-LEG ATTACHMENT DEVICES FOR USE WITH UTILITY LOCATORS; U.S. Pat. Application 16/551,653, filed Aug. 26, 2019, entitled BURIED UTILITY MARKER DEVICES, SYSTEMS, AND METHODS; U.S. Pat. 10,401,526, issued Sep. 3, 2019, entitled BURIED UTILITY MARKER DEVICES, SYSTEMS, AND METHODS; U.S. Pat. 10,324,188, issued Oct. 9, 2019, entitled OPTICAL GROUND TRACKING APPARATUS, SYSTEMS, AND METHODS FOR USE WITH BURIED UTILITY LOCATORS; U.S. Pat. Application 16/446,456, filed Jun. 19, 2019, entitled DOCKABLE TRIPODAL CAMERA CONTROL U-NIT; U.S. Pat. Application 16/520,248, filed Jul. 23, 2019, entitled MODULAR BATTERY PACK APPARATUS, SYSTEMS, AND METHODS; U.S. Pat. 10,371,305, issued Aug. 6, 2019, entitled DOCKABLE TRIPODAL CAMERA CONTROL UNIT; U.S. Pat. 10,490,908, issued Nov. 26, 2019, entitled DUAL ANTENNA SYSTEMS WITH VARIABLE POLARIZATION; U.S. Pat. Application 16/701,085, filed Dec. 2, 2019, entitled MAP GENERATION, BASED ON UTILITY LINE POSITION AND ORIENTATION ESTIMATES; U.S. Pat. 10,534,105, issued Jan. 14, 2020, entitled UTILITY LOCATING TRANSMITTER APPARATUS AND METHODS; U.S. Pat. Application 16/773,952, filed Jan. 27, 2020, entitled MAGNETIC FIELD CANCELING AUDIO DEVICES; U.S. Pat. Application 16/780,813, filed Feb. 3, 2020, entitled RESILIENTLY DEFORMABLE MAGNETIC FIELD CORE APPARATUS AND APPLICATIONS; U.S. Pat. 10,555,086, issued Feb. 4, 2020, entitled MAGNETIC FIELD CANCELING AUDIO SPEAKERS FOR USE WITH BURIED UTILITY LOCATORS OR OTHER DEVICES; U.S. Pat. Application 16/786,935, filed Feb. 10, 2020, entitled SYSTEMS AND METHODS FOR UNIQUELY IDENTIFYING BURIED UTILITIES IN A MULTI-UTILITY ENVIRONMENT; U.S. Pat. 10,557,824, issued Feb. 11, 2020, entitled RESILIENTLY DEFORMABLE MAGNETIC FIELD TRANSMITTER CORES FOR USE WITH UTILITY LOCATING DEVICES AND SYSTEMS; U.S. Pat. Application 16/791,979, issued Feb. 14, 2020, entitled MARKING PAINT APPLICATOR APPARATUS; U.S. Pat. Application 16/792,047, filed Feb. 14, 2020, entitled SATELLITE AND MAGNETIC FIELD SONDE APPARATUS AND METHODS; U.S. Pat. 10,564,309, issued Feb. 18, 2020, entitled SYSTEMS AND METHODS FOR UNIQUELY IDENTIFYING BURIED UTILITIES IN A MULTI-UTILITY ENVIRONMENT; U.S. Pat. 10,571,594, issued Feb. 25, 2020, entitled UTILITY LOCATOR DEVICES, SYSTEMS, AND METHODS WITH SATELLITE AND MAGNETIC FIELD SONDE ANTENNA SYSTEMS; U.S. Pat. 10,569,952, issued Feb. 25, 2020, entitled MARKING PAINT APPLICATOR FOR USE WITH PORTABLE UTILITY LOCATOR; U.S. Pat. Application 16/810,788, filed Mar. 5, 2019, entitled MAGNETICALLY RETAINED DEVICE HANDLES; U.S. Pat. Application 16/827,672, filed Mar. 23, 2020, entitled DUAL ANTENNA SYSTEMS WITH VARIABLE POLARIZATION; U.S. Pat. Application 16/833,426, filed Mar. 27, 2020, entitled LOW COST, HIGH PERFORMANCE SIGNAL PROCESSING IN A MAGNETIC-FIELD SENSING BURIED UTILITY LOCATOR SYSTEM; U.S. Pat. 10,608,348, issued Mar. 31, 2020, entitled DUAL ANTENNA SYSTEMS WITH VARIABLE POLARIZATION; U.S. Pat. Application 16/837,923, filed Apr. 1, 2020, entitled MODULAR BATTERY PACK APPARATUS, SYSTEMS, AND METHODS INCLUDING VIRAL DATA AND/OR CODE TRANSFER; U.S. Pat. Application 17/235,507, filed Apr. 20, 2021, entitled UTILITY LOCATING DEVICES EMPLOYING MULTIPLE SPACED APART GNSS ANTENNAS; U.S. Provisional Pat. Application 63/015,692, filed Apr. 27, 2020, entitled SPATIALLY AND PROCESSING-BASED DIVERSE REDUNDANCY FOR RTK POSITIONING; U.S. Pat. Application 16/872,362, filed May 11, 2020, entitled BURIED LOCATOR SYSTEMS AND METHODS; U.S. Pat. Application 16/882,719, filed May 25, 2020, entitled UTILITY LOCATING SYSTEMS, DEVICES, AND METHODS USING RADIO BROADCAST SIGNALS; U.S. Pat. 10,670,766, issued Jun. 2, 2020, entitled UTILITY LOCATING SYSTEMS, DEVICES, AND METHODS USING RADIO BROADCAST SIGNALS; U.S. Pat. 10,677,820, issued Jun. 9, 2020, entitled BURIED LOCATOR SYSTEMS AND METHODS; U.S. Pat. Application 16/902,245, filed Jun. 15, 2020, entitled LOCATING DEVICES, SYSTEMS, AND METHODS USING FREQUENCY SUITES FOR UTILITY DETECTION; U.S. Pat. Application 16/902,249, filed Jun. 15, 2020, entitled USER INTERFACES FOR UTILITY LOCATORS; U.S. Pat. 10,690,795, issued Jun. 23, 2020, entitled LOCATING DEVICES, SYSTEMS, AND METHODS USING FREQUENCY SUITES FOR UTILITY DETECTION; U.S. Pat. Application 16/908,625, filed Jun. 22, 2020, entitled ELECTROMAGNETIC MARKER DEVICES WITH SEPARATE RECEIVE AND TRANSMIT ANTENNA ELEMENTS; U.S. Pat. 10,690,796, issued Jun. 23, 2020, entitled USER INTERFACES FOR UTILITY LOCATORS; U.S. Pat. Application 16/921,775, filed Jul. 6, 2020, entitled AUTO-TUNING CIRCUIT APPARATUS AND METHODS; U.S. Provisional Pat. Application 63/055,278, filed Jul. 22, 2020, entitled VEHICLE-BASED UTILITY LOCATING USING PRINCIPAL COMPONENTS; U.S. Pat. Application 16/995,801, filed Aug. 17, 2020, entitled UTILITY LOCATOR TRANSMITTER DEVICES, SYSTEMS, AND METHODS; U.S. Pat. Application 17/001,200, filed Aug. 24, 2020, entitled MAGNETIC SENSING BURIED UTLITITY LOCATOR INCLUDING A CAMERA; U.S. Pat. 16/995,793, filed Aug. 17, 2020, entitled UTILITY LOCATOR APPARATUS AND METHODS; U.S. Pat. 10,753,722, issued Aug. 25, 2020, entitled SYSTEMS AND METHODS FOR LOCATING BURIED OR HIDDEN OBJECTS USING SHEET CURRENT FLOW MODELS; U.S. Pat. 10,754,053, issued Aug. 25, 2020, entitled UTILITY LOCATOR TRANSMITTER DEVICES, SYSTEMS, AND METHODS WITH DOCKABLE APPARATUS; U.S. Pat. 10,761,233, issued Sep. 1, 2020, entitled SONDES AND METHODS FOR USE WITH BURIED LINE LOCATOR SYSTEMS; U.S. Pat. 10,761,239, issued Sep. 1, 2020, entitled MAGNETIC SENSING BURIED UTILITY LOCATOR INCLUDING A CAMERA; U.S. Pat. Application 17/013,831, filed Sep. 7, 2020, entitled MULTIFUNCTION BURIED UTILITY LOCATING CLIPS; U.S. Pat. 10,777,919, issued Sep. 15, 2020, entitled MULTIFUNCTION BURIED UTILITY LOCATING CLIPS; U.S. Pat. Application 17/020,487, filed Sep. 14, 2020, entitled ANTENNA SYSTEMS FOR CIRCULARLY POLARIZED RADIO SIGNALS; U.S. Pat. Application 17/068,156, filed Oct. 12, 2020, entitled DUAL SENSED LOCATING SYSTEMS AND METHODS; U.S. Provisional Pat. Application 63/091,67, filed Oct. 14, 2020, entitled ELECTRONIC MARKER-BASED NAVIGATION SYSTEMS AND METHODS FOR USE IN GNSS-DEPRIVED ENVIRONMENTS; U.S. Pat. 10,809,408, issued Oct. 20, 2020, entitled DUAL SENSED LOCATING SYSTEMS AND METHODS; U.S. Pat. 10,845,497, issued Nov. 24, 2020, entitled PHASE-SYNCHRONIZED BURIED OBJECT TRANSMITTER AND LOCATOR METHODS AND APPARATUS; U.S. Pat. 10,859,727, issued Dec. 8, 2020, entitled ELECTRONIC MARKER DEVICES AND SYSTEMS; U.S. Pat. 10,908,311, issued Feb. 2, 2021, entitled SELF-STANDING MULTI-LEG ATTACHMENT DEVICES FOR USE WITH UTILITY LOCATORS; U.S. Pat. 10,928,538, issued Feb. 23, 2021, entitled KEYED CURRENT SIGNAL LOCATING SYSTEMS AND METHODS; U.S. Pat. 10,935,686, issued Mar. 2, 2021, entitled UTILITY LOCATING SYSTEM WITH MOBILE BASE STATION; and U.S. Pat. 10,955,583, issued Mar. 23, 2021, entitled BORING INSPECTION SYSTEMS AND METHODS; U.S. Pat. 10,983,239, issued Apr. 20, 2021, entitled MULTI-FREQUENCY LOCATING SYSTEMS AND METHODS; U.S. Pat. 10,983,240, issued Apr. 20, 2021, entitled MAGNETIC UTILITY LOCATOR DEVICE AND METHOD; U.S. Pat. 10,989,830, issued Apr. 27, 2021, entitled UTILITY LOCATOR APPARATUS AND SYSTEMS; U.S. Pat. 11,014,734, issued May 25, 2021, entitled MARKING PAINT APPLICATOR APPARATUS; U.S. Pat. 11,029,439, issued Jun. 8, 2021, entitled UTILITY LOCATOR APPARATUS, SYSTEMS, AND METHODS; U.S. Provisional Pat. Application 63/212,713, filed Jun. 20, 2021, entitled DAYLIGHT VISIBLE AND MULTI-SPECTRAL LASER RANGEFINDERS AND ASSOCIATED METHODS AND UTILITY LOCATOR DEVICES; U.S. Pat. D922,885, issued Jun. 22, 2021, entitled BURIED UTILITY LOCATOR; U.S. Pat. Application 17/379,867, filed Jul. 19, 2021, entitled LOCATING DEVICES, SYSTEMS, AND METHODS USING FREQUENCY SUITES FOR UTILITY DETECTION; U.S. Pat. Application 17/382,040, filed Jul. 21, 2021, entitled VEHICLE-BASED UTILITY LOCATING USING PRINCIPAL COMPONENTS; U.S. Pat. 11,073,632, issued Jul. 27, 2021, entitled LOCATING DEVICES, SYSTEMS, AND METHODS USING FREQUENCY SUITES FOR UTILITY DETECTION; U.S. Pat. 11,092,712, issued Aug. 17, 2021, entitled UTILITY LOCATING SYSTEMS, DEVICES, AND METHODS USING RADIO BROADCAST SIGNALS; U.S. Pat. Application 17/461,833, filed Aug. 30, 2021, entitled COMBINED SATELLITE NAVIGATION AND RADIO TRANSCEIVER ANTENNA DEVICES; U.S. Pat. Application 17/467,435, filed Sep. 6, 2021, entitled TRACKABLE DIPOLE DEVICES, METHODS, AND SYSTEMS FOR USE WITH MARKING PAINT STICKS; U.S. Pat. Application 17/467,438, filed Sep. 6, 2021, entitled SATELLITE AND MAGNETIC FIELD SONDE APPARATUS AND METHODS; U.S. Pat. 11,137,513, issued Oct. 5, 2021, entitled INDUCTIVE CLAMP DEVICES, SYSTEMS, AND METHODS; U.S. Pat. 11,146,892, issued Oct. 12, 2021, entitled MAGNETIC FIELD CANCELING AUDIO DEVICES; U.S. Pat. Application 17/501,670, filed Oct. 14, 2021, entitled ELECTRONIC MARKER-BASED NAVIGATION SYSTEMS AND METHODS FOR USE IN GNSS-DEPRIVED ENVIRONMENTS; U.S. Pat. 11,156,737, issued Oct. 26, 2021, entitled BURIED OBJECT LOCATOR APPARATUS AND METHODS; U.S. Pat. 11,171,369, issued Nov. 9, 2021, entitled MODULAR BATTERY PACK APPARATUS, SYSTEMS, AND METHODS; U.S. Pat. Application 17/522,857, filed Nov. 9, 2021, entitled WIRELESS BURIED PIPE AND CABLE LOCATING SYSTEMS; U.S. Pat. Application 17/523,857, filed Nov. 10, 2021, entitled SONDE DEVICES INCLUDING A SECTIONAL FERRITE CORE STRUCTURE; U.S. Pat. 11,175,427, issued Nov. 16, 2021, entitled BURIED UTILITY LOCATING SYSTEMS WITH OPTIMIZED WIRELESS DATA COMMUNICATION; U.S. Pat. Application 17/531,533, filed Nov. 19, 2021, entitled INPUT MULTIPLEXED SIGNAL PROCESSING APPARATUS AND METHODS; U.S. Pat. Application 17/540,239, filed Dec. 1, 2021, entitled DUAL SENSED LOCATING SYSTEMS AND METHODS; U.S. Pat. Application 17/541,057, filed Dec. 2, 2021, entitled COLOR-INDEPENDENT MARKER DEVICE APPARATUS, SYSTEMS, AND METHODS; U.S. Pat. Application 17/540,231, filed Dec. 2, 2021, entitled AUTO-TUNING CIRCUIT APPARATUS AND METHODS; U.S. Pat. 11,193,767, issued DECEMBER 7, 2021, entitled SMART PAINT STICK DEVICES AND METHODS; U.S. Pat. 11,199,521, issued Dec. 14, 2021, entitled RESILIENTLY DEFORMABLE MAGNETIC FIELD CORE APPARATUS AND APPLICATIONS; U.S. Pat. 11,204,246, issued Dec. 21, 2021, entitled DUAL SENSED LOCATING SYSTEMS AND METHODS; U.S. Provisional Pat. Application 63/293,828, filed Dec. 26, 2021, entitled MODULAR BATTERY SYSTEMS INCLUDING BATTERY INTERFACE APPARATUS; U.S. Pat. Application 17/563,049, filed Dec. 28, 2021, entitled SONDE DEVICES WITH A SECTIONAL FERRITE CORE; U.S. Provisional Pat. Application 63/306,088, filed Feb. 2, 2022, entitled UTILITY LOCATING SYSTEMS AND METHODS WITH FILTER TUNING FOR POWER GRID FLUCTUATIONS; U.S. Pat. Application 17/687,538, filed Mar. 4, 2022, entitled ANTENNAS, MULTI-ANTENNA APPARATUS, AND ANTENNA HOUSINGS; U.S. Pat. Application 17/694,640, filed Mar. 14, 2022, entitled UTILITY LOCATORS WITH RETRACTABLE SUPPORT STRUCTURES AND APPLICATIONS THEREOF; U.S. Pat. Application 17/694,656, filed Mar. 14, 2022, entitled ELECTROMAGNETIC MARKER DEVICES FOR BURIED OR HIDDEN USE; U.S. Pat. 11,280,934, issued Mar. 22, 2022, entitled ELECTROMAGNETIC MARKER DEVICES FOR BURIED OR HIDDEN USE; U.S. Pat. 11,300,597, issued Apr. 12, 2022, entitled SYSTEMS AND METHODS FOR LOCATING AND/OR MAPPING BURIED UTILITIES USING VEHICLE-MOUNTED LOCATING DEVICES; U.S. Pat. 11,300,700, issued Apr. 12, 2022, entitled SYSTEMS AND METHODS OF USING A SONDE DEVICE WITH A SECTIONAL FERRITE CORE STRUCTURE; U.S. Pat. 11,300,701, issued Apr. 12, 2022, entitled UTILITY LOCATORS WITH RETRACTABLE SUPPORT STRUCTURES; U.S. Pat. Application 17/728,949, filed Apr. 25, 2022, entitled BURIED UTILITY LOCATOR GROUND TRACKING APPARATUS, SYSTEMS, AND METHODS; U.S. Pat. Application 17/731,579, filed Apr. 28, 2022, entitled BURIED UTILITY MARKER DEVICES, SYSTEMS, AND METHODS; U.S. Pat. 11,333,786, issued May 17, 2022, entitled BURIED UTILITY MARKER DEVICES, SYSTEMS, AND METHODS; U.S. Pat. Application 17/833,799, filed Jun. 6, 2022, entitled TRACKED DISTANCE MEASURING DEVICES, SYSTEMS, AND METHODS; U.S. Pat. Application 17/845,290, filed Jun. 21, 2022, entitled DAYLIGHT VISIBLE AND MULTI-SPECTRAL LASER RANGEFINDERS AND ASSOCIATED SYSTEMS AND METHODS AND UTILITY LOCATOR DEVICES; U.S. Pat. 11,366,245, issued Jun. 21, 2022, entitled BURIED UTILITY LOCATOR GROUND TRCKING APPARATUS, SYSTEMS, AND METHODS; U.S. Provisional Pat. Application 63/368,879, filed Jul. 19, 2022, entitled NATURAL VOICE UTILITY ASSET ANNOTATION SYSTEM; U.S. Pat. 11,397,274, issued Jul. 26, 2022, entitled TRACKED DISTANCE MEASURING DEVICES, SYSTEMS, AND METHODS; U.S. Pat. 11,428,814, filed Aug. 30, 2022, entitled OPTICAL GROUND TRACKING APPARATUS, SYSTEMS, AND METHODS FOR USE WITH BURIED UTILITY LOCATORS; and U.S. Pat. Application 17/930,029, filed Sep. 6, 2022, entitled GNSS POSITIONING METHODS AND DEVICES USING PPP-RTK, RTK, SSR, OR LIKE CORRECTION DATA. The content of each of the above-described patents and applications is incorporated by reference herein in its entirety. The above applications may be collectively denoted herein as the “co-assigned applications” or “incorporated applications.”

Articles hereby incorporated by reference herein in their entirety include:
https://www.section.io/engineering-education/understanding-pattern-recognition-in-machine-learning/#:~:text=Pattern%20recognition%20is%20the%20use%20of%20machine%20learning% 20algorithms%20to,to%20train%20pattern%20recognition%20systems;
https://en.wikipedia.org/wiki/Deep_learning;https://www.nature.com/articles/d41586-020-03348-4; https://deepmind.com/research/case-studies/alphago-the-story-so-far; and https://readwrite.com/2019/11/02/machine-learning-for-translation-whats-the-state-of-the-language-art/;http://sciencewise.info/media/pdf/1507.08818v1.pdf

### BRIEF DESCRIPTION OF THE DRAWINGS

FIG. 1 is an illustration of different methods for collecting multifrequency electromagnetic data from buried objects associated with utilities or communication systems, as known in the prior art.

FIG. 2 is an illustration of an embodiment of a method of using Deep Learning/artificial intelligence to recognize patterns and make predictions related to underground utilities, in accordance with certain aspects of the present invention.

FIG. 3 is an illustration of an embodiment of a system, including a service worker using a portable locator and a Sonde to collect electromagnetic frequency data or other data from underground or buried assets, in accordance with certain aspects of the present invention.

FIG. 4 is an illustration of an embodiment of a system, including a vehicle equipped with a locator to collect electromagnetic frequency data or other data from underground or buried assets, in accordance with certain aspects of the present invention.

FIG. 5 is an illustration of an embodiment of a method of providing Training Data to a Neural Network to use Deep Learning/artificial intelligence to recognize patterns and make predictions related to underground utilities, in accordance with certain aspects of the present invention.

FIG. 6 is an illustration of an embodiment of a method of using Artificial Intelligence (AI) to classify collected data based on a predicted probability, and to test the accuracy of the prediction, as known in the prior art.

FIG. 7 is an illustration of an embodiment of a data base structure for using Artificial Intelligence (AI) to recognize patterns, in accordance with certain aspects of the present invention.

FIG. 8 is an illustration of an embodiment of a chart showing various types of collected and other data as Training Data for Deep Learning in a Neural Network that uses Artificial Intelligence (AI), in accordance with certain aspects of the present invention.

### DETAILED DESCRIPTION OF EMBODIMENTS

It is noted that as used herein, the term “exemplary” means “serving as an example, instance, or illustration.” Any aspect, detail, function, implementation, and/or embodiment described herein as “exemplary” is not necessarily to be construed as preferred or advantageous over other aspects and/or embodiments.

### Example Embodiments

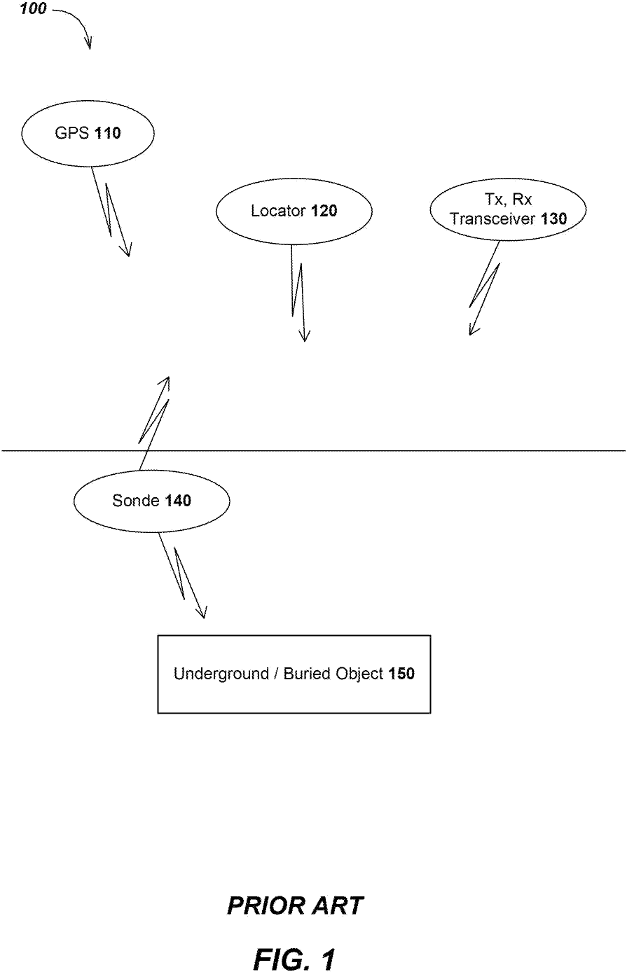

FIG. 1 illustrates details of an exemplary embodiment of different methods 100 for collecting multifrequency electromagnetic data from buried objects associated with utilities 150. Methods 100 may include collecting data from various apparatus with the ability to receive, measure, or sense single or multifrequency electromagnetic data from under or above ground sources. The various apparatus may include one or more of the following: GPS or other satellite systems 110, utility or other locator systems 120, equipment with one or more transmitters, receivers, or transceivers 130, Sonde equipment 140, and many other types of utility sensing equipment well known by those skilled in the art.

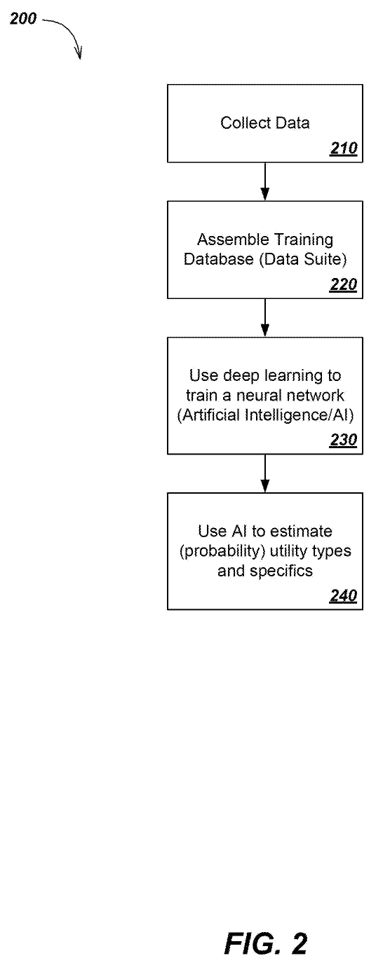

FIG. 2 illustrates details of an exemplary method 200 of using Deep Learning/Artificial Intelligence (AI) to recognize patterns and make predictions related to underground utilities. The method starts at block 210 collecting data and proceeds to block 220 where a Training Data Base, also known as a Data Suite or Training Data Suite, is assembled. The method then proceeds to block 230 where Deep Learning is used to train a Neural Network using Artificial Intelligence. Finally, the method proceeds to block 240 where AI estimates the probability that underground or buried objects or assets are specific types of equipment or utilities, or have other characteristics and specifics, including but not limited to current and/or voltage data, even and odd harmonics data, active and/or passive signal data, and spatial relationship data. It would be understood by one or ordinary skill in the art that there is an almost endless amount of characteristics and specifics related to utility equipment and assets.

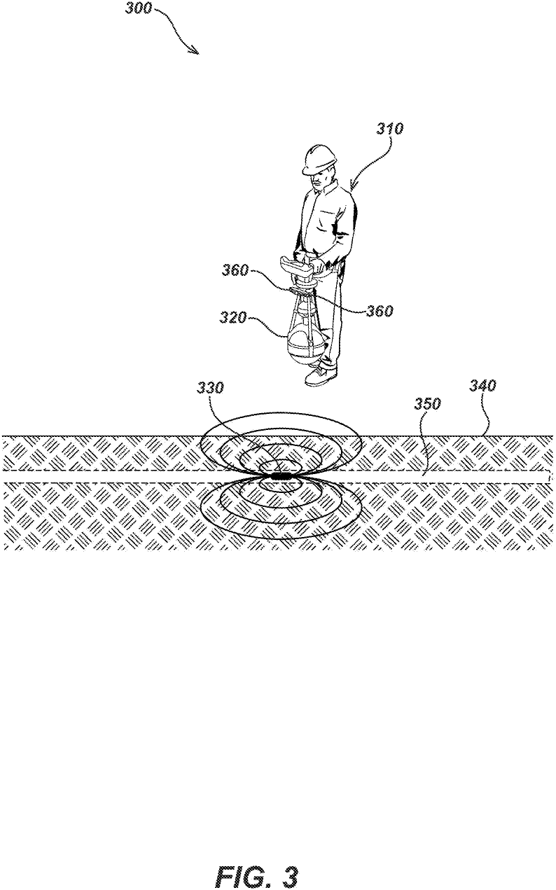

FIG. 3 illustrates details of an exemplary embodiment 300 of a system including a service worker 310 using a portable locator 320, and a Sonde 330 located underground 340 to collect single or multifrequency electromagnetic data from an underground or buried utility asset 350. In some embodiments, system 300 may include one or more cameras 360 which could be attached to, or integral with portable locator 320, or could be located separately.

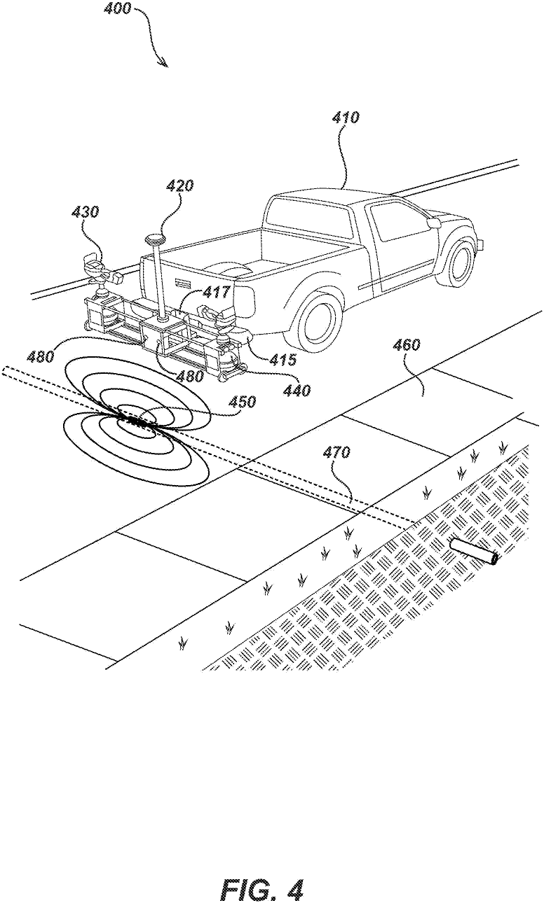

FIG. 4 illustrates details of an exemplary embodiment 400 of a system including a vehicle 410 equipped with an omni-directional antenna 420, a locator 430, a dodecahedron antenna 440, and a Sonde 450 located underground 460, used to collect single or multifrequency electromagnetic data from an underground or buried utility asset 470. In some embodiments, system 400 may include one or more cameras 480 which could be attached to, or integral with vehicle 410, 415 or a mount 417 connected to the vehicle 410 and/or bumper 415, or could be located separately.

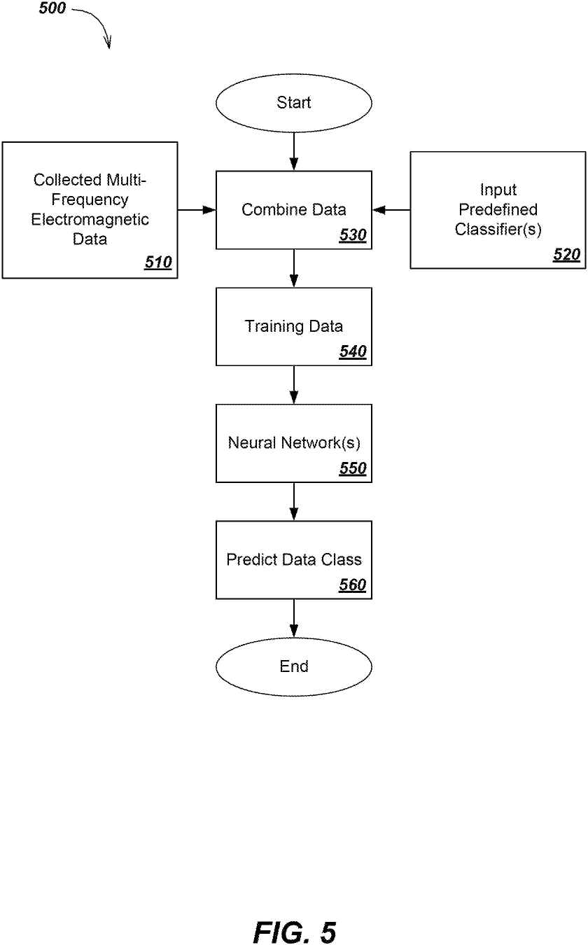

FIG. 5 illustrates details of an exemplary embodiment 500 of a method of providing Training Data to a Neural Network to use Deep Learning/artificial intelligence to recognize patterns and make predictions related to underground utilities. Multifrequency Electromagnetic Data 510 may be collected from multiple sources, any Predefined Classifier(s) 520 may be inputted or entered by a user, and both may be combined in block 530. Other data such as image data, harmonics data, etc. may also be combined in block 530. The Combined data is also known as a Data Suite. Data combined at 530 becomes available to be used as Training Data, also known as a Training Data Suite, at block 540. The Training Data 540 is then provided to one or more Neural Networks 550 which use Deep Learning to predict one or more data classes 560 for the underground or buried assets related to utility and communication systems. Artificial Intelligence (AI) is used to provide a probability that specific assets have specific characteristics, have relationships between other assets, and fall into one or more classification or categories by using the Training Data to recognize patterns.

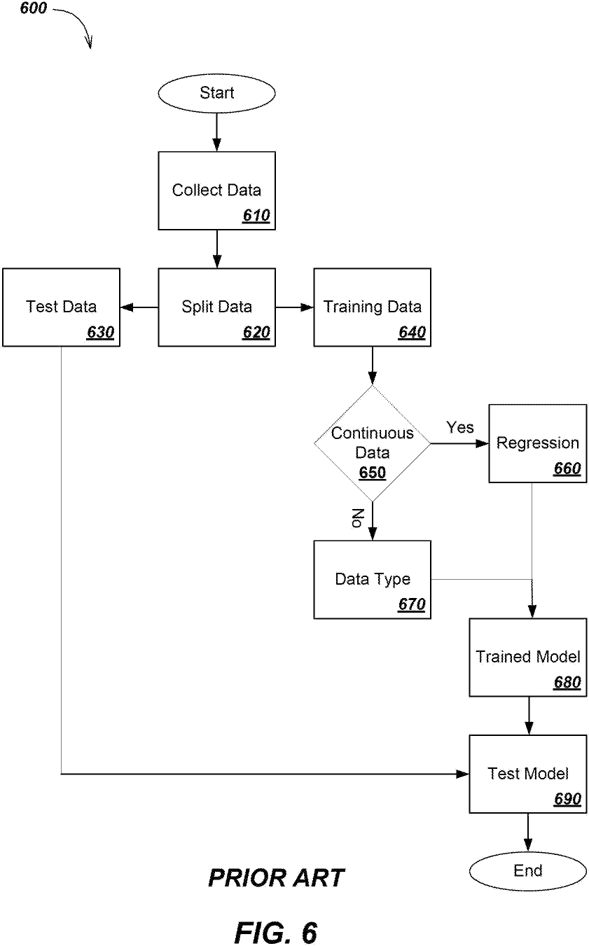

FIG. 6 illustrates details of an exemplary embodiment 600 of a method of providing test data to a Deep Learning system that uses Artificial Intelligence (AI) to check the accuracy of determined predictions, as known in the prior art. The method starts by Collecting Data 610. This step is followed by Splitting the Data 620 into Test Data 630 and Training Data 640. In decision block 650 it is determined whether the Training Data 640 is continuous (YES), or non-continuous (NO). If the answer is YES, the method proceeds to block 660 for Regression Testing; if the answer is NO, the method proceeds to block 670 to determine a Data Type (e.g. electromagnetic data, video data, user inputted classifications or categories, etc.). In block 680 the Trained Model is determined using AI based on the Training Data provided, and in block 690 the accuracy of the Trained Model is tested using the Test Data 630.

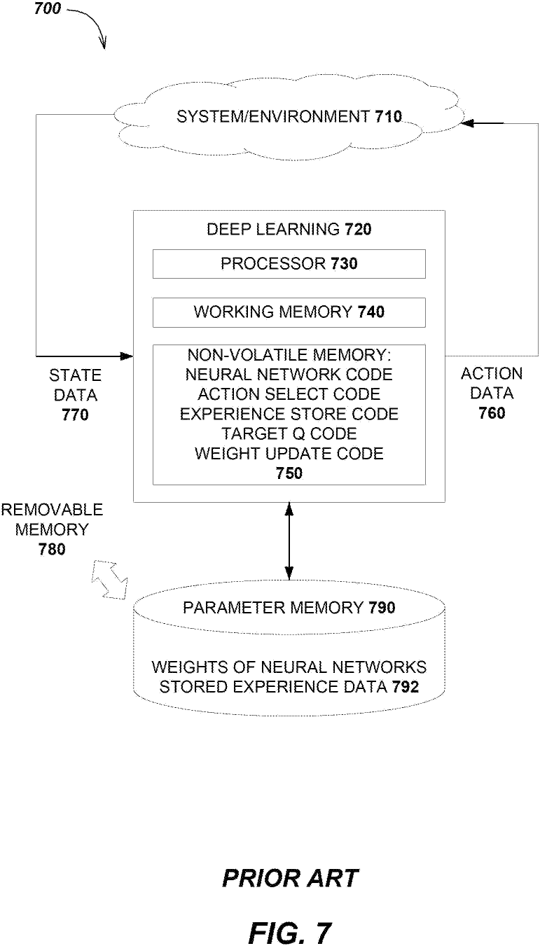

FIG. 7 illustrates details of an exemplary embodiment 700 of a database structure for using Artificial Intelligence (AI) to recognize patterns, as known in the prior art. The database structure includes a System/Environment 710, Deep Learning 720 which includes a Processor 730, Working Memory 740, and Non-Volatile Memory 750. In some embodiments, Experience Store Code and Target Q Code may be optionally stored in Non-Volatile Memory 750 in order to facilitate the use of a second or subsequent Neural Network. The Experience Data and Q Code would be provided to a first Neural Network to generate target values for training a second or subsequent Neural Network. In Block 760 Action Data is provided to the System/Environment 710 which outputs State Data 770. Removable Memory 780 is provided, as well as a Parameter Memory 790. Weights of one or more Neural Networks 792 are provided to Deep Learning 720.

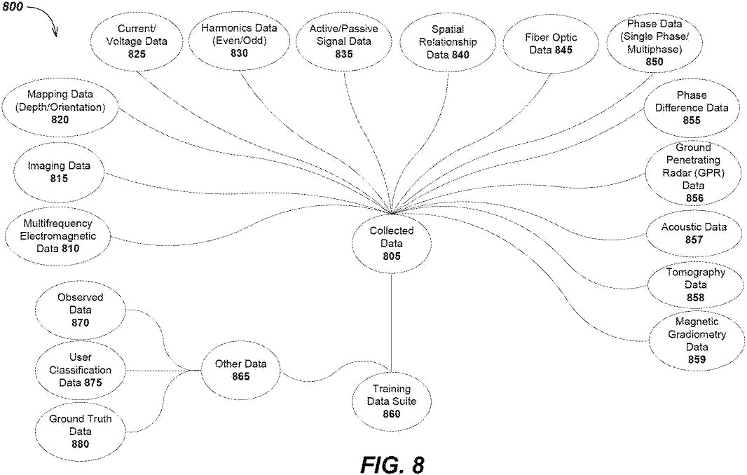

FIG. 8 illustrates details of an exemplary embodiment 800 of a chart showing various types of collected and other data as Training Data for Deep Learning in a Neural Network that uses Artificial Intelligence (AI). Collected Data 805 may include Multifrequency Electromagnetic Data 810, Imaging Data 815, Mapping Data 820 which may include Depth and/or Orientation Data, Current and/or Voltage Data 825, Harmonics Data 830 including Even and /or Odd Harmonics Data, Active and/or Passive Signal Data 835, Spatial Relationship Data 840, Fiber Optic Data 845, Phase Data 850 which may include Single Phase or Multiphase Data, Phase Difference Data 855, Ground Penetrating Radar Data (GPR) 856, Acoustic Data 857, Tomography Data 858, and Magnetic Gradiometry Data 859. It is contemplated that additional types of Collected Data 805 related to utilities and communication systems could also be used, and would be apparent to those skilled in the art. Training Suite Data 860, which may include Collected Data 805, may also include Other Data 865. Other Data 865 may include one or more of the following: Observed Data 870, User Classification Data 875, and Ground Truth Data 880. It is contemplated that additional types of Other Data 865 related to utilities and communication systems could also be used, and would be apparent to those skilled in the art. Some examples of such data are paint marks including previous paint on the ground, pipeline markers, overhead utilities/powerlines, construction techniques uses, e.g. trenchfill (conductivity and magnetic permeability), local ground conductivity, type of equipment in operation on the grid. For instance, equipment could include horizontal drilling equipment that generally runs generally straight between a drill “in” pit and a drill “out pit. There are of course innumerable types of equipment that could be operating on the grid at any given time, these are well known in the art. Collected can include data collected walking and/or by vehicle including air collected data such as data collected by a drone. Collected data can be used separately or combined from multiple sources.

The scope of the invention is not intended to be limited to the aspects shown herein but are to be accorded the full scope consistent with the disclosures herein and their equivalents, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use embodiments of the present invention. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the disclosures herein and in the appended drawings.

We claim:

1. A system for determining and distinguishing buried objects using Artificial Intelligence (AI) comprising:
a receiving element for collecting at least one of multifrequency electromagnetic signal data and communication signal data (“collected data”);
an input element for allowing a user to input one or more predefined classifiers;
a processor for combining at least a portion of the collected data with at least one predefined classifier, wherein the processor outputs Training Data;
at least one Neural Network for processing the Training Data using Deep Learning performed by Artificial Intelligence (AI), and classifying the collected data based on a predicted probability; and
an output element for presenting the classification data to a user.

2. The system of claim 1, wherein the receiving element comprises at least one of a locator, Sonde, transmitting antenna, receiving antenna, transceiver, inductive clamp, electrical clip, or a satellite system.

3. The system of claim 1, wherein Training Data further includes imaging data collected from a camera or imaging element.

4. The system of claim 1, wherein Training Data further includes sensor data.

5. The system of claim 1, wherein Training Data further includes mapping data.

6. The system of claim 5, wherein mapping data includes at least one of depth or orientation data.

7. The system of claim 1, wherein Training Data further includes fiber optic data.

8. The system of claim 1, wherein Training Data further includes one or more of image data, current and/or voltage data, even and odd harmonics data, active and/or passive signal data, and spatial relationship data.

9. The system of claim 1, wherein Training Data further includes one or more of phase data and phase difference data.

10. The system of claim 1, wherein Training Data further includes other data.

11. The system of claim 10, wherein other data comprises one or more of observed data, user classification data, and ground truth data.

12. The system of claim 11, wherein ground truth data comprises one or more of ownership data, manufacturer data, connection data, utility box or junction data, and obstacle data.

13. The system of claim 1, wherein Training Data may be processed and classified in real time, or stored and post-processed in the Cloud.

14. The system of claim 1, wherein classifying the collected data comprises determining at least one of a utility type, electrical characteristics, connection type, asset type, manufacturer type, ownership type, location type, direction type, right of way type, or damaged asset type.

15. The system of claim 1, wherein the output element comprises one or more of a visual display, a speaker or other sound producing element, and a vibration or other tactile producing element.

16. A computer implemented method for determining and distinguishing buried objects using Artificial Intelligence (AI) comprising:
collecting at least one of multifrequency electromagnetic signal data and communication signal data (“collected data”) from a plurality of sources;
using the collected data alone or in combination with user predefined classifiers as Training Data;
providing the Training Data to at least one Neural Network;
using at least one Neural Network for processing the Training Data using Deep Learning performed by Artificial Intelligence (AI) and classifying the collected data based on a predicted probability; and
organizing and presenting the classified data to a user.

17. The method of claim 16, wherein collecting the at least one of multifrequency electromagnetic signal data and communication signal data comprises receiving the data from at least one of a locator, Sonde, transmitting antenna, receiving antenna, transceiver, inductive clamp, electrical clip, or a satellite system.

18. The method of claim 16, wherein Training Data may further include imaging data collected from a camera or imaging element.

19. The method of claim 16, wherein Training Data further includes sensor data.

20. The method of claim 16, wherein Training Data further includes mapping data.

21. The method of claim 20, wherein mapping data includes at least one of depth or orientation data.

22. The method of claim 16, wherein Training Data further includes fiber optic data.

23. The method of claim 16, wherein Training Data further includes one or more of image data, current and/or voltage data, even and odd harmonics data, active and/or passive signal data, and spatial relationship data.

24. The method of claim 16, wherein Training Data further includes one or more of phase data, phase difference data, ground penetrating radar (GPR) data, acoustic data, and tomography data.

25. The method of claim 16, wherein Training Data further includes other data.

26. The method of claim 25, wherein other data comprises one or more of observed data, user classification data, ground truth data, physics model data, and ground return current data.

27. The method of claim 26, wherein ground truth data comprises one or more of ownership data, manufacturer data, connection data, utility box or junction data, and obstacle data.

28. The method of claim 16, wherein Training Data may be processed and classified in real time, or stored and post-processed in the cloud.

29. The method of claim 16, wherein classifying the collected data comprises determining at least one of a utility type, electrical characteristics type, connection type, asset type, manufacturer type, ownership type, location type, direction type, right of way type, or damaged asset type.

30. The method of claim 16, wherein presenting classified data to a user comprises an output element including one or more of a visual display, a speaker or other sound producing element, and a vibration or other tactile producing element.
